(19) United States
(12) Patent Application Publication
(10) Pub. No.: US 2026/0159318 A1
(43) Pub. Date: Jun. 11, 2026

(54) BATTERY MANAGEMENT SYSTEM AND CONTROL METHOD THEREOF

(71) Applicant: SK On Co., Ltd., Seoul (KR)

(72) Inventors: Dong Yeop CHU, Daejeon (KR); Kang Hyuk CHOI, Daejeon (KR); Soo Ho CHO, Daejeon (KR); Jeong Hun KIM, Daejeon (KR)

(21) Appl. No.: 19/412,887

(22) Filed: Dec. 9, 2025

(30) Foreign Application Priority Data
Dec. 10, 2024 (KR) 10-2024-0182665

(51) Int. Cl. B65G 1/04; H01M 10/42

(52) U.S. Cl. CPC B65G 1/0435; H01M 10/425; H01M 2010/4271

(57) ABSTRACT

The present disclosure relates to a battery management system and a control method thereof. The battery management system of this disclosure may comprise: a receiving room for accommodating battery cells within a space partitioned along a first predetermined direction and a second direction; a first transfer device including a carriage forming an internal accommodating space, and a moving unit configured to move the carriage; a second transfer device configured to move the carriage; and a deck extending from the receiving room along a third direction and being partially open along the first direction to form an open space.

### CROSS-REFERENCE TO RELATED PATENT APPLICATION

The present application claims priority under 35 U.S.C. § 119a to Korean patent applications number 10-2024-0182665 filed on Dec. 10, 2024 in the Ministry of Intellectual Property in Korea, the entire disclosures of which are incorporated by reference herein.

### BACKGROUND OF THE DISCLOSURE

### 1. Field

This disclosure relates to a battery management system and a control method thereof.

### 2. Description of the Related Art

The manufacturing process of a lithium-ion battery is broadly comprised of an electrode manufacturing process, a cell manufacturing process, and a formation process. The formation process may consist of a charge-discharge process that imparts electrical characteristics to the battery cell through charging and inspects the discharge capacity, an aging process that sufficiently disperses the electrolyte to create an optimal state, and a process that screens out defective cells containing foreign matter.

During the assembly process, battery cells may be moved using the carriage of a stacker crane. Therefore, there is a need for a method to replace damaged or low-quality carriages to ensure the safe movement of battery cells.

According to one aspect of the present disclosure, an object is to improve the stability of battery cells.

According to another aspect of the present disclosure, an object is to safely move battery cells.

According to another aspect of the present disclosure, an object is to facilitate the replacement of the carriage.

According to another aspect of the present disclosure, an object is to improve the time required to replace the carriage.

Meanwhile, the present invention may be widely applied in the fields of electric vehicles, battery charging stations, energy storage systems, and other green technologies utilizing batteries, such as photovoltaics and wind power. Furthermore, the present invention may be used in eco-friendly mobility, including electric vehicles and hybrid vehicles, to prevent climate change by suppressing air pollution and greenhouse gas emissions.

### SUMMARY OF THE DISCLOSURE

A battery management system according to an embodiment of this disclosure may comprise: a receiving room for accommodating battery cells within a space partitioned along a first predetermined direction and a second direction indicating a height direction perpendicular to the first direction; a first transfer device including a carriage forming an internal accommodating space, and a moving unit configured to move the carriage to introduce or withdraw the battery cells into or from the accommodating space or the receiving room; a second transfer device connected to the carriage and configured to move the carriage from the first transfer device to the outside of the first transfer device; and a deck extending from the receiving room along a third direction perpendicular to the first and second directions and being partially open along the first direction to form an open space; wherein the carriage may be raised and lowered along the second direction through the open space.

In an embodiment, the battery management system may further comprise: a transfer trolley on which the carriage is placed, and for moving the carriage along the first direction on the deck to a designated region where the open space to be formed.

In an embodiment, the second transfer device may move the carriage from the first transfer device to the transfer trolley to place the carriage onto the transfer trolley.

In an embodiment, the second transfer device may raise and lower the carriage placed on the transfer trolley along the second direction when the carriage moves to the designated region via the transfer trolley, and wherein the transfer trolley may leave the designated region when the carriage is raised and lowered along the second direction.

In an embodiment, the battery management system may further comprise: a control device, wherein the control device may control the deck to form the open space when the transfer trolley leaves the designated region.

In an embodiment, the transfer trolley may further include: a stand including an insertion hole; a traveling trolley including a connecting member inserted into the insertion hole and a moving member for moving the carriage; and a sliding trolley on which the carriage is positioned and which slides between the stand and the traveling trolley.

In an embodiment, the traveling trolley further may include a bendable fixing member for fixing the sliding trolley, which is slidably moved on the traveling trolley, and the traveling trolley.

In an embodiment, the stand may further include a stopper to prevent the sliding trolley from sliding onto the traveling trolley, wherein the stopper may be removed to allow the sliding trolley to slide from the stand onto the traveling trolley when the carriage is placed on the sliding trolley, wherein the stand and the traveling trolley may be separated after the sliding trolley is slid onto the traveling trolley.

A control method for a battery management system, including a receiving room for accommodating battery cells within a space partitioned along a first predetermined direction and a second direction indicating a height direction perpendicular to the first direction, a first transfer device including a carriage forming an internal accommodating space, and a moving unit configured to move the carriage to introduce or withdraw the battery cells into or from the accommodating space or the receiving room, a second transfer device connected to the carriage and configured to move the carriage from the first transfer device to the outside of the first transfer device, and a deck extending from the receiving room along a third direction perpendicular to the first and second directions and being partially open along the first direction to form an open space, the control method according to another embodiment of this disclosure may comprise: a step of moving the carriage from the first transfer device to a designated region via the second transfer device; a step of opening a portion of the deck corresponding to the designated region to form an open space based on determining that a designated event has been detected; and a step of lowering the carriage through the open space along the second direction via the second transfer device.

In another embodiment, the step of moving the carriage to the designated region may include: a step of placing the carriage on a transfer trolley positioned on the deck from the first transport device via the second transport device; and a step of moving the carriage to the designated region via the transfer trolley.

In another embodiment, the control method may further comprise: a step of moving the carriage along the second direction through the second transfer device after the carriage is moved to the designated region, and a step of moving the transfer trolley to leave the designated region.

In another embodiment, the control method may further comprise: a step of determining that the designated event has been detected based on the step of moving the transfer trolley leaving the designated region.

In another embodiment, the transfer trolley may further include a stand including an insertion hole, a traveling trolley including a connecting member inserted into the insertion hole and a moving member for moving the carriage and a sliding trolley on which the carriage is positioned and which slides between the stand and the traveling trolley, wherein the step of placing the carriage on a transfer trolley may include a step of placing the carriage on the sliding trolley via the second transfer device, a step of removing the stopper, a step of sliding the sliding trolley onto the traveling trolley, and a step of separating the stand and the traveling trolley.

In another embodiment, the traveling trolley may further include a bendable fixing member fixing the sliding trolley and the traveling trolley, and the control method of the battery management system may further include a step of fixing the sliding trolley and the traveling trolley via the fixing member.

In another embodiment, the control method may further comprise: a step of removing a safety fence surrounding the first transfer device.

According to an embodiment of the present disclosure, the stability of the battery cell may be improved.

According to another embodiment of the present disclosure, the battery cell may be safely moved.

According to another embodiment of the present disclosure, replacement of the carriage may be facilitated.

According to another embodiment of the present disclosure, the time required to replace the carriage may be improved.

### BRIEF DESCRIPTION OF THE DRAWINGS

FIG. 1 is a diagram illustrating an example of the first transfer device.

FIG. 2 is a drawing illustrating another example of the first transfer device.

FIGS. 3A and 3B are drawings illustrating a deck according to the present disclosure.

FIG. 4 is a drawing illustrating a transfer trolley according to the present disclosure.

FIG. 5 is a drawing illustrating a stand according to the present disclosure.

FIG. 6 is a drawing illustrating a sliding trolley according to the present disclosure.

FIG. 7 is a drawing illustrating a traveling trolley according to the present disclosure.

FIG. 8 is a drawing illustrating a method for moving a carriage on a deck using the second transfer device and the transfer trolley according to the present disclosure.

FIG. 9 is a block diagram schematically illustrating the battery management system according to the present disclosure.

FIG. 10 is a flowchart illustrating a control method for the battery management system according to the present disclosure.

### DETAILED DESCRIPTION

The following describes in detail embodiments of the present disclosure with reference to the accompanying drawings. The configuration of the apparatus and the control method described below are intended only to explain the embodiments of the present disclosure and are not intended to limit the scope of the present disclosure. Reference numbers used throughout the specification denote the same components.

Specific terms used herein are for convenience of description only and are not intended to limit the exemplary embodiments described.

For example, expressions such as “same” and “same as” not only indicate a strictly identical state, but also indicate a state in which there is a difference in tolerance, or the degree to which the same function is obtained.

Expressions indicating relative or absolute arrangement, such as “in any direction,” “along any direction,” “parallel,” “perpendicular,” “toward the center,” “concentric,” or “coaxial,” indicate not only strictly such arrangement but also a state where components are relatively displaced with tolerances or angles/distances that achieve the same function.

The use of terms such as “first,” “second,” “third,” etc., preceding components mentioned below is solely to avoid confusion regarding the components being referred to and is unrelated to any order, importance, or master-servant relationship among the components. For example, an invention including only the second component without the first component is also realizable.

Unless the context clearly indicates otherwise, singular expressions used in this specification may include plural expressions.

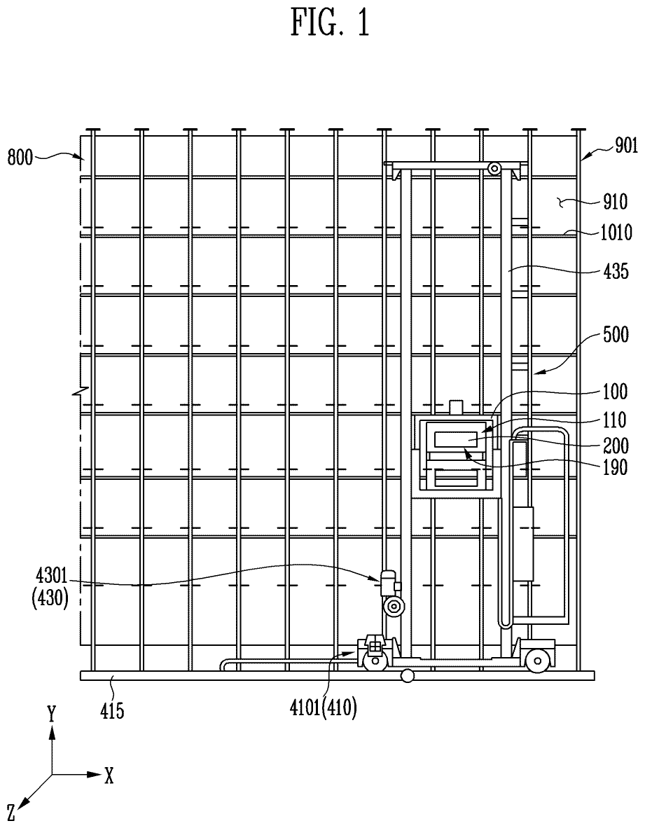

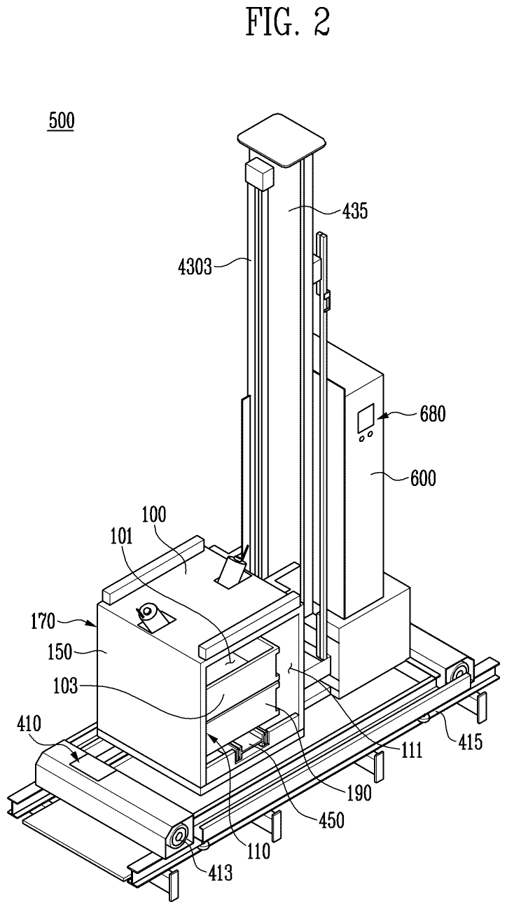

FIG. 1 is a diagram illustrating an example of the first transfer device. FIG. 2 is a drawing illustrating another example of the first transfer device.

In an embodiment, a battery management system may comprise: a receiving room 910 for accommodating battery cells 200 within a space partitioned along a first predetermined direction and a second direction indicating a height direction perpendicular to the first direction, a first transfer device 500 including a carriage 100 forming an internal accommodating space 101, and a moving unit 450 configured to move the carriage 110 to introduce or withdraw the battery cells 200 into or from the accommodating space 101 or the receiving room 910, a second transfer device 730 connected to the carriage 110 and configured to move the carriage 110 from the first transfer device 500 to the outside of the first transfer device 500, and a deck 1010 extending from the receiving room 910 along a third direction perpendicular to the first and second directions and being partially open along the first direction to form an open space, wherein the carriage 110 may be raised and lowered along the second direction through the open space.

Referring to FIGS. 1 and 2, the first transfer device 500 may transport battery cells 200 during the manufacturing process and introduce or withdraw it into or from a receiving room 910 located in the battery formation device 901. The battery formation device 901 may be a charging-discharging device that charges and discharges manufactured battery cells 200 to impart electrical characteristics, or an aging device that stores the battery cells 200 at a constant temperature and humidity. The first transfer device 500 may also be named a stacker crane or a battery transport device.

The first transfer device 500 may transport manufactured battery cells 200 to a target receiving room 910 for the activation process, and may also transport processed battery cells 200 to other battery activation devices within the activation process or to subsequent processes.

The receiving room 910 may be a charging-discharging room that accommodates battery cells 200 to perform the charge or discharge process, or an aging room that accommodates battery cells 200 to perform the aging process.

The receiving room 910 may be implemented in a plurality. An arrangement of the plurality of receiving room 910 in a first direction (X-axis direction) may be referred to as a processing rack 800. Furthermore, the receiving room 910 may be arranged in a second direction (Y-axis direction) representing the height direction among the directions perpendicular to the first direction (X-axis direction). For example, the first direction (X-axis direction), the second direction (Y-axis direction), and the third direction (Z-axis direction) may be mutually orthogonal.

The receiving room 910 may include spaces partitioned along the first direction (X-axis direction) and the second direction (Y-axis direction).

The first transfer device 500 includes a carriage 100 forming an internal accommodating space 101, referring to FIG. 2, for accommodating battery cells 200 internally, and a first inlet 111 communicating with the accommodating space 101. The battery cells 200 may be placed inside a transfer member 103, 190 or tray for movement. The transfer member 103, 190 may be detachably placed within the accommodating space 101 of the carriage 100.

The carriage 100 includes a carriage front 110 forming the front of the carriage 100, a carriage rear 170 located at the rear of the carriage 100 facing the carriage front 110 and including a second inlet (not shown) communicating with the accommodating space 101, carriage sides 150 forming both sides of the carriage 100 and connecting the carriage front 110 and carriage rear 170, and a carriage top 120 connecting the carriage front 110, the carriage surface rear 170, and the carriage sides 150, and forming the upper surface of the carriage 100.

The first inlet 111 and the second inlet (not shown) may be provided facing each other. Battery cells 200 may be introduced into or withdrawn from the accommodating space 101 through the first inlet 111 and the second inlet (not shown).

The first transfer device 500 may include a first travel portion 410 for moving the carriage 100 in a direction parallel to the carriage front 110 (first direction, X-axis direction), a second travel portion 430 for moving the carriage 100 in the height direction of the carriage 100 (second direction, Y-axis direction), and a moving unit 450 capable of moving along the front-rear direction (third direction, Z-axis direction) of the carriage 100 to introduce into or withdraw from the battery cells 200 of the accommodating space 101. For example, the moving unit 450 may be named a fork.

The first transfer device 500 further includes a travel rail 415 provided in a direction parallel to the first inlet 111 (first direction, X-axis direction), and the first travel portion 410 may move the carriage 100 along the travel rail 415. For this purpose, the first travel portion 410 may further include a first drive motor 4101 that generates rotational force and a first drive wheel 413 that rotates due to the rotation of the first drive motor 4101.

The first transfer device 500 may further include a mast 435 positioned on the outer side of the carriage 100 and extending along the height direction (second direction, Y-axis direction) of the carriage 100.

The second travel portion 430 may move the carriage 100 along the mast 435 in the height direction (second direction, Y-axis direction) of the carriage 100.

The second travel portion 430 includes a second drive motor 4301 that generates rotational force, a cable 4303 connected to the second drive motor 4301 and supported by the mast 435, and a drive wheel that rotates driven by the second drive motor 4301 to wind or unwind the cable 4303.

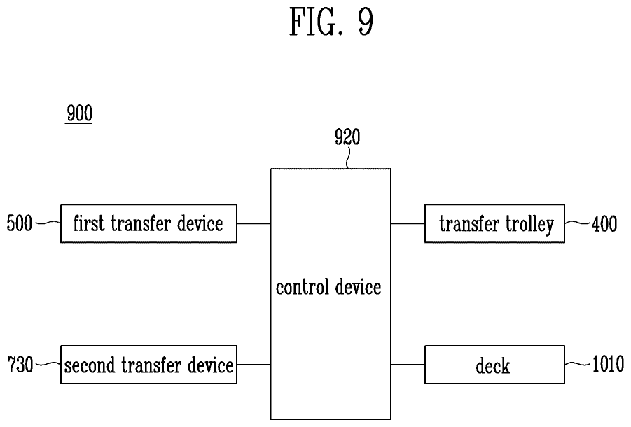

The first transfer device 500 may include a controller 600 for the first transfer device 500 located outside the carriage 100 to control the movement of the first transfer device 500. However, this is merely one example, as long as the first transfer device 500 may be controlled, the controller 600 of the first transfer device 500 may be located elsewhere. Alternatively, the first transfer device 500 may be controlled by the control device 920, referring to FIG. 9, described later.

The controller 600 of the first transfer device 500 is provided on the outer side of the carriage 100 and may be protected by a housing. Furthermore, the first transfer device 500 may additionally include an input/output unit 680 provided on the housing, which receives user input and outputs the status of the first transfer device 500 or the processing result of the received command to the user.

The battery formation device 901 may further include a deck 1010 extending from the receiving room 910 in a third direction (Z-axis direction) perpendicular to the first and second directions. The deck 1010 may be formed as a plate-shaped space extending in the first direction (X-axis direction). Similar to the receiving room 910 formed by stacking in the second direction (Y-axis direction), the deck 1010 may also be formed by stacking in the second direction (Y-axis direction). The deck 1010 may include a region where an operator or user can move.

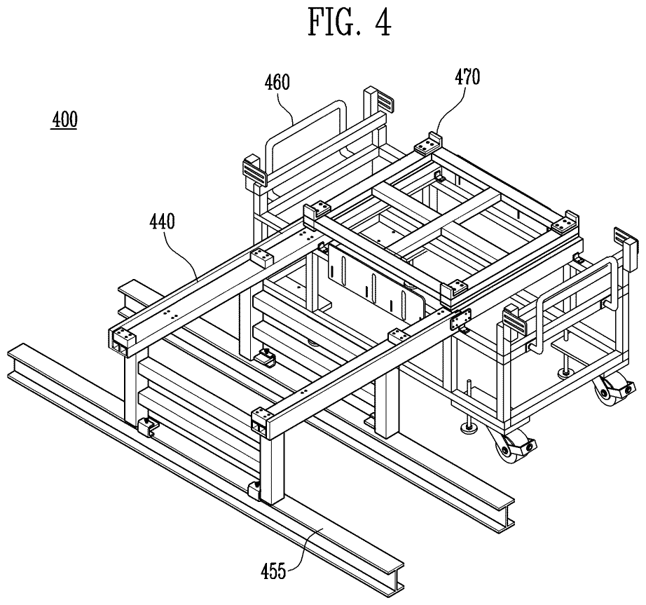

Rails 455, referring to FIG. 4, may be placed on the deck 1010. Through the rail 455, an object placed on the rail 455 (e.g., a stand 440 in FIG. 4) on the deck 1010 may be moved.

The deck 1010 may optionally be partially open along a first direction to form an open space. In this case, the deck 1010, formed by stacking in a second direction (Y-axis direction), may have corresponding regions along the second axis direction (Y-axis direction) opened together.

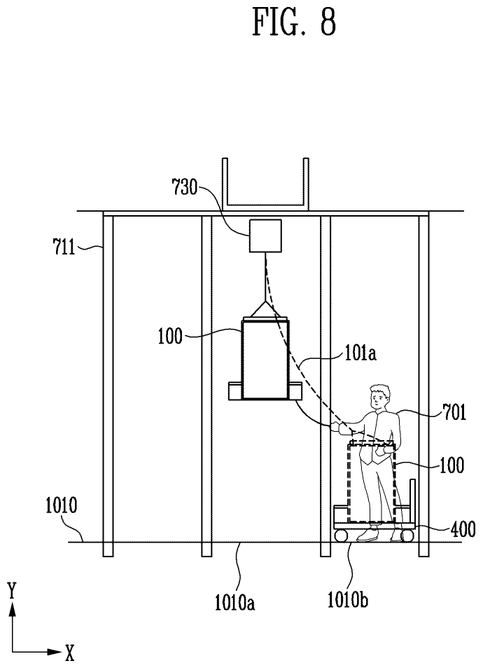

The battery formation device 901 may further include a second transfer device 730, referring to FIG. 8. In an embodiment, the second transfer device 730 may move the carriage 100 from the first transfer device 500 to the transfer trolley 400 to place the carriage 100 onto the transfer trolley 400. For example, the second transfer device 730 may move the carriage 100 from the first transfer device 500 to the outside of the first transfer device 500. For example, the second transfer device 730, referring to FIG. 8, may be connected to the carriage 100. The second transfer device 730 may be named a hoist. The second transfer device 730 may be a device included in each deck 1010.

In an embodiment, the second transfer device 730 may raise and lower the carriage 100 placed on the transfer trolley 400 along the second direction when the carriage 100 moves to the designated region via the transfer trolley 400, and the transfer trolley 400 may leave the designated region when the carriage 100 is raised and lowered along the second direction.

For example, the second transfer device 730 may raise and lower the carriage 100 in the second direction (Y-axis direction) through the open space of the deck 1010.

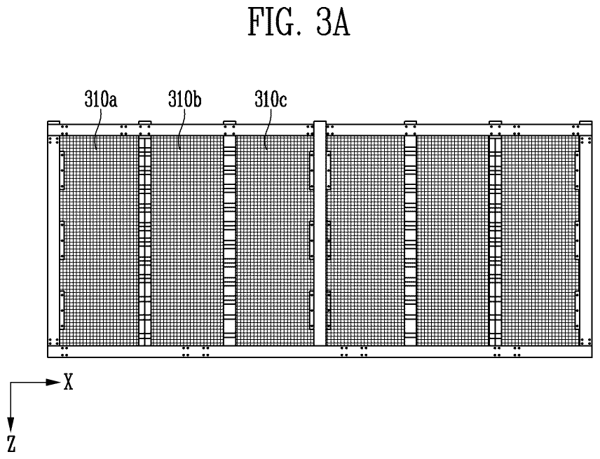

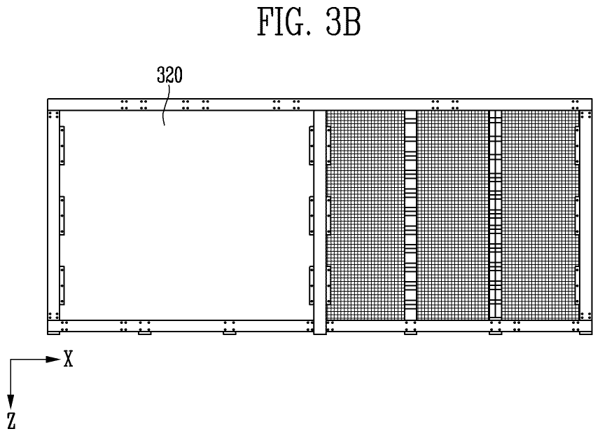

FIGS. 3A and 3B are drawings illustrating a deck according to the present disclosure.

Specifically, FIGS. 3A and 3B show a view of the deck 1010 included in the battery formation device 901 of FIG. 1 as seen in the second direction (Y-axis direction).

Referring to FIGS. 3A and 3B, the deck 1010 according to the present disclosure may be formed extending from the receiving room 910 in a third direction (Z-axis direction). The deck 1010 may include designated regions 310a, 310b, 310c to be opened.

A sensing device may be disposed on the deck 1010 according to the present disclosure. When the sensing device detects that the transfer trolley 400, referring to FIG. 4, has leave the designated area, the deck 1010 may open the designated regions 310a, 310b, 310c to form an open space 320.

The deck 1010 may also open the designated regions 310a, 310b, 310c to form an open space 320 based on confirmation of user input via an input device instructing it to open the designated regions 310a, 310b, 310c.

The deck 1010 may be moved along a first direction (X-axis direction) to form an open space 320. Alternatively, the deck 1010 may be moved along a third direction (Z-axis direction) to form an open space 320.

FIG. 4 is a drawing illustrating a transfer trolley according to the present disclosure.

In an embodiment, the battery management system may further comprise: a transfer trolley 400 on which the carriage 100 is placed, and for moving the carriage 100 along the first direction on the deck 1010 to a designated region where the open space to be formed.

For example, referring to FIG. 4, the transfer trolley 400 according to the present disclosure may include a stand 440, a traveling trolley 460, and a sliding trolley 470.

According to one embodiment, the stand 440 may be connected to rails 455. The rails 455 may be disposed on the deck 1010.

According to one embodiment, the stand 440 may be connected to the traveling trolley 460. According to one embodiment, the sliding trolley 470 may slide between the traveling trolley 460 and the stand 440.

According to one embodiment, the sliding trolley 470 can slide from the stand 440 to the traveling trolley 460 and engage with the traveling trolley 460. According to one embodiment, the stand 440 may be separated from the traveling trolley 460. According to one embodiment, the stand 440 may be moved via the rails 455.

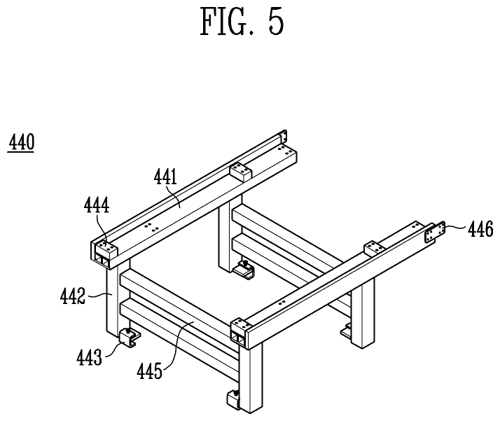

FIG. 5 is a drawing illustrating a stand according to the present disclosure.

Referring to FIG. 5, the stand 440 according to the present disclosure may include a first support frame 441, a second support frame 442, and a third support frame 445. The first support frame 441, the second support frame 442, and the third support frame 445 may each be implemented in a plurality. The number of each of the first support frame 441, the second support frame 442, and the third support frame 445 may not be limited to the number shown in FIG. 5.

The first support frame 441 may be connected to the second support frame 442 and arranged in mutually perpendicular directions. The first support frame 441 may include an insertion hole into which the traveling trolley 460 may be inserted to connect with the traveling trolley 460.

The second support frame 442 may be connected to the first support frame 441 and the third support frame 445. The second support frame 442 may be arranged in a direction perpendicular to the third support frame 445.

The stand 440 according to this disclosure may further include a fixing bracket 443. The fixing bracket 443 may be connected to the rails 455 to prevent the rails 455 and the stand 440 from separating.

In an embodiment, the stand 440 may further include a stopper 444 to prevent the sliding trolley 470 from sliding onto the traveling trolley 460, the stopper 444 may be removed to allow the sliding trolley 470 to slide from the stand 440 onto the traveling trolley 460 when the carriage 100 is placed on the sliding trolley 470, and the stand 440 and the traveling trolley 460 may be separated after the sliding trolley 470 is slid onto the traveling trolley 460.

For example, the stand 440 according to this disclosure may further include a first stopper 444. The first stopper 444 may be positioned on the first support frame 441. The first stopper 444 may serve to secure the sliding trolley 470 positioned on the stand 440 to prevent it from moving toward the traveling trolley 460. After the carriage 100 is positioned on the sliding trolley 470, the first stopper 444 may be removed.

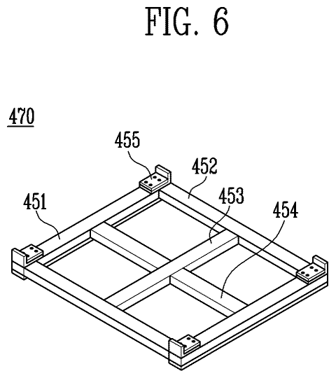

FIG. 6 is a drawing illustrating a sliding trolley according to the present disclosure.

Referring to FIG. 6, the sliding trolley 470 according to the present disclosure may include a plurality of frames 451, 452, 453, 454 arranged perpendicular to each other.

The sliding trolley 470 according to the present disclosure may further include a second stopper 455. The second stopper 455 may serve to secure the carriage 100 positioned on the sliding trolley 470 to prevent movement of the carriage 100.

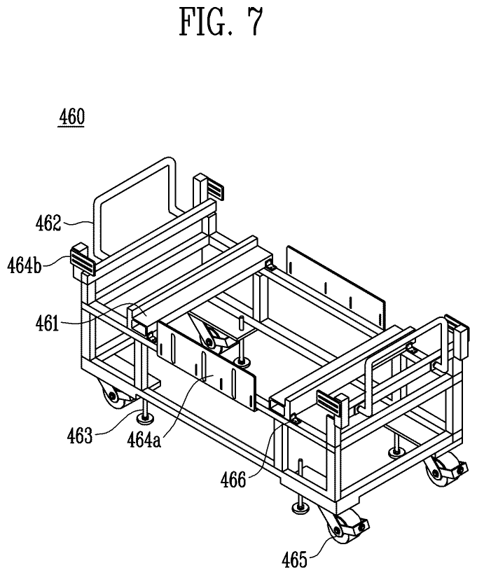

FIG. 7 is a drawing illustrating a traveling trolley according to the present disclosure.

Referring to FIG. 7, the traveling trolley 460 includes a handle 462 grasped by a user, a connecting plate 461 connectable to the stand 440, a connecting member 466 connectable between the stand 440 and the connecting plate 461, a moving member 465 for moving the traveling trolley 460, an adjusting member 463 for adjusting the height of the traveling trolley 460, and fixing members 464a, 464b for fixing the carriage 100 placed on the sliding trolley 470.

The sliding trolley 470 may slide via the connecting plate 461 and be positioned on the connecting plate 461.

In an embodiment, the traveling trolley 460 may further include a bendable fixing member 464a, 464b for fixing the sliding trolley 470, which is slidably moved on the traveling trolley 460, and the traveling trolley 460.

For example, the fixing members 464a, 464b may be formed in a bendable shape. According to one embodiment, when the sliding trolley 470 is placed on the connecting plate 461, the fixing members 464a, 464b may be bent to prevent the carriage 100 from moving on the traveling trolley 460.

In an embodiment, the battery management system may further comprise: a control device 920, wherein the control device 920 may control the deck 1010 to form the open space when the transfer trolley 400 leaves the designated region.

For example, the traveling trolley 460 may be moved by a user. Alternatively, the traveling trolley 460 may be moved under the control of a control device 920.

FIG. 8 is a drawing illustrating a method for moving a carriage on a deck using the second transfer device and the transfer trolley according to the present disclosure.

Referring to FIG. 8, the deck 1010 may be stacked and arranged along a second direction (Y-axis direction). The deck 1010 may be interconnected via support member 711.

According to one embodiment, a second transfer device 730 may be connected to one of the adjacent the deck 1010. According to one embodiment, the other adjacent deck 1010 may be provided as a space where the user and the transfer trolley can move.

Hereinafter, the operation of separating the carriage 100 placed on the first transfer device 500 by the second transfer device 730 will be described.

According to one embodiment, the second transfer device 730 may include a chain 101a and a drive unit. The chain 101a may be connected to the carriage 100 placed on the first transfer device 500. The drive unit may be implemented as a motor that raises and lowers the chain 101a.

According to one embodiment, the transfer trolley 400 may be positioned in a first region 1010b of the deck 1010.

According to one embodiment, the second transfer device 730 may place the carriage 100, connected to the chain 101a, onto the transfer trolley 400 positioned in the first region 1010b.

Hereinafter, the operation of lifting the carriage 100 placed on the transfer trolley 400 positioned in the first region 1010b by the second transfer device 730 will be described.

According to one embodiment, the transfer trolley 400 with the carriage 100 placed thereon may be moved to the second region 1010a among the deck 1010.

According to one embodiment, the second transfer device 730 may raise and lower the carriage 100 connected to the chain 101a.

According to one embodiment, when the carriage 100 is raised or lowered, the transfer trolley 400 may be disengaged from the second region 1010a of the deck 1010. For example, the transfer trolley 400 may be disengaged from the second region 1010a by the user 701 or by control of the control device 920.

Hereinafter, the operation of lowering the carriage 100 through an open space of the deck 1010 by the second transfer device 730 shall be described.

According to one embodiment, when the transfer trolley 400 leaves the second region 1010a, the second region 1010a, which represents a designated region of the deck 1010, may be opened.

According to one embodiment, the second transfer device 730 may lower the carriage 100 into the open space of the deck 1010.

FIG. 9 is a block diagram schematically illustrating the battery management system according to the present disclosure.

Referring to FIG. 9, the battery management system 900 according to the present disclosure may include a first transfer device 500, a second transfer device 730, a transfer trolley 400, a deck 1010, and a control device 920.

The control device 920 may control operations performed by components included in the battery management system 900 according to the present disclosure. That is, operations performed by the first transfer device 500, the second transfer device 730, the transfer trolley 400, and the deck 1010 may be operations performed under the control of the control device 920.

The battery management system 900 according to the present disclosure may represent a system capable of transporting a carriage 100 carrying battery cells contained within the first transfer device 500 to a designated location from the first transfer device 500 when the carriage 100 is damaged due to factors such as fire and requires replacement.

According to one embodiment, the first transfer device 500 includes a carriage 100 forming an internal accommodating space 101, a moving unit 450 that moves the carriage 100 to withdraw battery cells from the accommodating space 101 into an receiving room 910 or to withdraw battery cells from the receiving room 910 into the accommodating space 101. For example, the moving unit 450 may represent a fork. The first transfer device 500 may be surrounded by a safety fence.

According to one embodiment, the second transfer device 730 is connected to the carriage 100 and may move the carriage 100 from the first transfer device 500 to the outside of the first transfer device 500. For example, the second transfer device 730 may represent a hoist.

According to one embodiment, the deck 1010 extends from the receiving room in a third direction (e.g., the Z-axis direction in FIG. 1) and may be partially open in a first direction (e.g., the X-axis direction in FIG. 1) to form an open space. According to one embodiment, the transfer trolley 400 may move the carriage 100 on the deck 1010.

In an embodiment, the transfer trolley 400 may further include a stand 440 including an insertion hole, a traveling trolley 460 including a connecting member 466 inserted into the insertion hole and a moving member 465 for moving the carriage 100, and a sliding trolley 470 on which the carriage 100 is positioned and which slides between the stand 440 and the traveling trolley 460.

For example, the transfer trolley 400 may include a stand 440, a traveling trolley 460, and a sliding trolley 470. The stand 440 may be connected to the traveling trolley 460. The sliding trolley 470 may slide between the stand 440 and the traveling trolley 460.

Hereinafter, a system capable of transporting the carriage 100 included in the first transfer device 500 to a designated location will be described in detail.

According to one embodiment, a safety fence surrounding the first transfer device 500 may be removed. For example, the safety fence may be removed by a user, or the safety fence may be automatically removed by a control device 920.

According to one embodiment, the second transfer device 730 may place the carriage 100 from the first transfer device 500 onto a transfer trolley 400 positioned on the deck 1010. For example, the second transfer device 730 may place the carriage 100 on a sliding trolley 470. According to one embodiment, after the carriage 100 is placed on the sliding trolley 470, the sliding trolley 470 may be slid from the stand 440 to the traveling trolley 460. According to one embodiment, the stand 440 is separated from the traveling trolley 460, and the sliding trolley 470 and the traveling trolley 460 may be fixed.

According to one embodiment, the traveling trolley 460 with the sliding trolley 470 fixed thereto may move the carriage 100 to a designated region on the deck 1010. The designated region may represent a region on the deck 1010 where an open space is formed along the first direction.

According to one embodiment, the second transfer device 730 may move raise or lowered the carriage 100 along a second direction. According to one embodiment, the traveling trolley 460 with the sliding trolley 470 fixed may be leave from the designated region after the carriage 100 has been moved raise or lowered along the second direction.

According to one embodiment, when the sliding trolley 470 fixed to the fixed traveling trolley 460 is leave the designated region, a portion of the deck 1010 may be opened to form an open space.

The battery management system 900 according to the present disclosure may further include a sensor device. For example, the control device 920 may control the deck 1010 to open a portion thereof and form an open space based on sensing, via the sensor device, that the sliding trolley 470 has leave the designated region relative to the fixed traveling trolley 460.

The battery management system 900 according to the present disclosure may further include an input device. For example, the control device 920 may also control the deck 1010 to open a portion thereof to form an open space based on confirming a user input through the input device to open a portion of the deck 1010 to form an open space.

According to one embodiment, the second transfer device 730 may move or lower the carriage 100 along a second direction through the open space.

According to one embodiment, when the carriage 100 is moved or lowered along the second direction through the open space and positioned at a designated location, the carriage 100 may be separated from the second transfer device 730. For example, the designated location may represent a designated location where the carriage 100 may be repaired. The designated location may be preset by the user via an input device or automatically set by the control device 920.

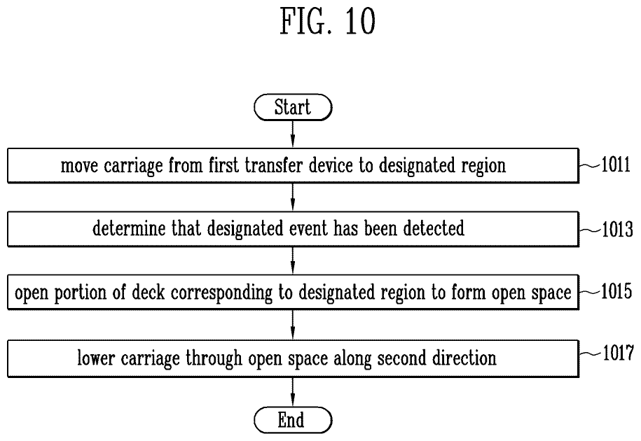

FIG. 10 is a flowchart illustrating a control method for the battery management system according to the present disclosure.

In an embodiment, a control method for a battery management system, including a receiving room for accommodate battery cells within a space partitioned along a first predetermined direction and a second direction indicating a height direction perpendicular to the first direction, a first transfer device including a carriage forming an internal accommodating space, and a moving unit configured to move the carriage to introduce or withdraw the battery cells into or from the accommodating space or the receiving room, a second transfer device connected to the carriage and configured to move the carriage from the first transfer device to the outside of the first transfer device, and a deck extending from the receiving room along a third direction perpendicular to the first and second directions and being partially open along the first direction to form an open space, the control method comprising: a step of moving the carriage from the first transfer device to a designated region via the second transfer device; a step of opening a portion of the deck corresponding to the designated region to form an open space based on determining that a designated event has been detected; and a step of lowering the carriage through the open space along the second direction via the second transfer device.

For example, referring to FIG. 10, the control method for the battery management system 900 according to the present disclosure may include, in an operation 1011, a step of moving the carriage 100 from the first transfer device 500 to a designated region. For example, the designated region may represent a region where a portion of the deck 1010 is open along a first direction, forming an open space. The control method for the battery management system 900 according to this disclosure may further include a step of removing a safety fence surrounding the first transfer device 500. That is, the control method of the battery management system 900 according to this disclosure may include a step of moving the carriage 100 from the first transfer device 500 to the designated region after the safety fence surrounding the first transfer device 500 has been removed.

The control method of the battery management system 900 according to the present disclosure may include a step of placing the carriage 100 onto a transfer trolley 400 positioned on the deck 1010 via the second transfer device 730.

According to one embodiment, the control method for the battery management system 900 according to the present disclosure may include a step of moving the carriage 100 onto a sliding trolley 470 via the second transfer device 730. At this time, the first stopper 444 positioned on the stand 440 may be removed.

According to one embodiment, the control method of the battery management system 900 according to the present disclosure may include a step of sliding the sliding trolley 470 onto the traveling trolley 460 when the carriage 100 is placed on the sliding trolley 470.

In an embodiment, the step of moving the carriage to the designated region may include a step of placing the carriage on a transfer trolley positioned on the deck from the first transport device via the second transport device and a step of moving the carriage to the designated area via the transfer trolley.

For example, the control method of the battery management system 900 according to the present disclosure may include a step of separating the stand 440 and the traveling trolley 460 when the sliding trolley 470 slides onto the traveling trolley 460. According to one embodiment, the control method of the battery management system 900 according to the present disclosure may include a step of fixing the sliding trolley 470 and the traveling trolley 460 when the stand 440 and the traveling trolley 460 are separated.

In an embodiment, the control method may further comprise a step of moving the carriage along the second direction through the second transfer device after the carriage is moved to the designated region, and a step of moving the transfer trolley to leave the designated region.

For example, the control method of the battery management system 900 according to the present disclosure may include a step of moving the carriage 100 to a designated region along a first direction via the transfer trolley 400. The control method for the battery management system 900 according to the present disclosure may include a step of moving the carriage 100 along a second direction via a second transfer device 730 when the transfer trolley 400 moves to the designated region. The control method of the battery management system 900 according to this disclosure may include a step of moving the transfer trolley 400 away from the designated region when the carriage 100 moves along the second direction via the second transfer device 730.

The control method for the battery management system 900 according to this disclosure may include a step of determining that a designated event has been detected in operation 1013. The control method for the battery management system 900 according to this disclosure may include a step of determining or confirming that the designated event has been detected when the transfer trolley 400 leave the designated region.

The control method for the battery management system 900 according to this disclosure may include, in an operation 1015, a step of opening a portion of the deck 1010 corresponding to the designated region to form an open space, based on the determining that the designated event has been detected.

In an embodiment, the transfer trolley may further include a stand including an insertion hole, a traveling trolley including a connecting member inserted into the insertion hole and a moving member for moving the carriage and a sliding trolley on which the carriage is positioned and which slides between the stand and the traveling trolley, wherein the step of placing the carriage on a transfer trolley includes a step of placing the carriage on the sliding trolley via the second transfer device, a step of removing the stopper, a step of sliding the sliding trolley onto the traveling trolley, and a step of separating the stand and the traveling trolley.

For example, the control method for the battery management system 900 according to this disclosure may include, in an operation 1017, lowering the carriage 100 through the open space along a second direction via the second transfer device 730. The control method for the battery management system 900 according to this disclosure may include a step of separating the carriage 100 from the second transfer device 730 when the carriage 100 is lowered through the open space along the second direction and positioned at the designated location. For example, the designated location may represent a designated location where the carriage 100 may be repaired.

The present disclosure may be practiced in various forms of modification and is not limited to the above-described embodiments. Therefore, if a modified embodiment includes the components of the claims of the present disclosure, it should be considered within the scope of the present disclosure.

What is claimed is:

1. A battery management system comprising:
a receiving room for accommodating battery cells within a space partitioned along a first predetermined direction and a second direction indicating a height direction perpendicular to the first direction;
a first transfer device including a carriage forming an internal accommodating space, and a moving unit configured to move the carriage to introduce or withdraw the battery cells into or from the accommodating space or the receiving room;
a second transfer device connected to the carriage and configured to move the carriage from the first transfer device to the outside of the first transfer device; and
a deck extending from the receiving room along a third direction perpendicular to the first and second directions and being partially open along the first direction to form an open space;
wherein the carriage is raised and lowered along the second direction through the open space.

2. The battery management system according to claim 1, further comprising:
a transfer trolley on which the carriage is placed, and for moving the carriage along the first direction on the deck to a designated region where the open space to be formed.

3. The battery management system according to claim 2, wherein the second transfer device moves the carriage from the first transfer device to the transfer trolley to place the carriage onto the transfer trolley.

4. The battery management system according to claim 3, wherein the second transfer device raises and lowers the carriage placed on the transfer trolley along the second direction when the carriage moves to the designated region via the transfer trolley, and
wherein the transfer trolley leaves the designated region when the carriage is raised and lowered along the second direction.

5. The battery management system according to claim 4, further comprising:
a control device,
wherein the control device controls the deck to form the open space when the transfer trolley leaves the designated region.

6. The battery management system according to claim 2, wherein the transfer trolley further includes:
a stand including an insertion hole;
a traveling trolley including a connecting member inserted into the insertion hole and a moving member for moving the carriage; and
a sliding trolley on which the carriage is positioned and which slides between the stand and the traveling trolley.

7. The battery management system according to claim 6, wherein the traveling trolley further includes a bendable fixing member for fixing the sliding trolley, which is slidably moved on the traveling trolley, and the traveling trolley.

8. The battery management system according to claim 6, wherein the stand further includes a stopper to prevent the sliding trolley from sliding onto the traveling trolley,
wherein the stopper is removed to allow the sliding trolley to slide from the stand onto the traveling trolley when the carriage is placed on the sliding trolley,
wherein the stand and the traveling trolley are separated after the sliding trolley is slid onto the traveling trolley.

9. A control method for a battery management system, including a receiving room for accommodating battery cells within a space partitioned along a first predetermined direction and a second direction indicating a height direction perpendicular to the first direction, a first transfer device including a carriage forming an internal accommodating space, and a moving unit configured to move the carriage to introduce or withdraw the battery cells into or from the accommodating space or the receiving room, a second transfer device connected to the carriage and configured to move the carriage from the first transfer device to the outside of the first transfer device, and a deck extending from the receiving room along a third direction perpendicular to the first and second directions and being partially open along the first direction to form an open space, the control method comprising:
a step of moving the carriage from the first transfer device to a designated region via the second transfer device;
a step of opening a portion of the deck corresponding to the designated region to form an open space based on determining that a designated event has been detected; and
a step of lowering the carriage through the open space along the second direction via the second transfer device.

10. The control method according to claim 9, wherein the step of moving the carriage to the designated region includes:
a step of placing the carriage on a transfer trolley positioned on the deck from the first transport device via the second transport device; and
a step of moving the carriage to the designated region via the transfer trolley.

11. The control method according to claim 10, further comprising:
a step of moving the carriage along the second direction through the second transfer device after the carriage is moved to the designated region, and
a step of moving the transfer trolley to leave the designated region.

12. The control method according to claim 11, further comprising:
a step of determining that the designated event has been detected based on the step of moving the transfer trolley leaving the designated region.

13. The control method according to claim 10, wherein the transfer trolley further includes a stand including an insertion hole, a traveling trolley including a connecting member inserted into the insertion hole and a moving member for moving the carriage and a sliding trolley on which the carriage is positioned and which slides between the stand and the traveling trolley,
wherein the step of placing the carriage on a transfer trolley includes a step of placing the carriage on the sliding trolley via the second transfer device, a step of removing the stopper, a step of sliding the sliding trolley onto the traveling trolley, and a step of separating the stand and the traveling trolley.

14. The control method according to claim 13, wherein the traveling trolley further includes a bendable fixing member fixing the sliding trolley and the traveling trolley, and
the control method of the battery management system further includes a step of fixing the sliding trolley and the traveling trolley via the fixing member.

15. The control method according to claim 9, further comprising:
a step of removing a safety fence surrounding the first transfer device.
